(19) United States
(12) Patent Application Publication
(10) Pub. No.: US 2022/0215234 A1
(43) Pub. Date: Jul. 7, 2022

(54) DETERMINING SCHEDULES FOR PROCESSING NEURAL NETWORKS ON HARDWARE

(71) Applicant: Microsoft Technology Licensing, LLC, Redmond, WA (US)

(72) Inventors: Karthikeyan Avudaiyappan, Sunnyvale, CA (US); Jeffrey Andrews, Sunnyvale, CA (US)

(21) Appl. No.: 17/144,030

(22) Filed: Jan. 7, 2021

(51) Int. Cl. G06N 3/06; G06F 17/16; G06N 3/08

(52) U.S. Cl. CPC G06N 3/06; G06N 3/08; G06F 17/16

(57) ABSTRACT

Embodiments of the present disclosure include systems and methods for determining schedules for processing neural networks on hardware. A set of instructions for processing data through a neural network is received. Based on a hardware definition specifying the set of hardware units and functions that each hardware unit in the set of the hardware unit is configured to perform, a schedule of a set of operations to be performed by a subset of the set of hardware units to implement the set of instructions are determined. The schedule of the set of operations are distributed to the subset of the set of hardware units.

### BACKGROUND

The present disclosure relates to computing hardware. More particularly, the present disclosure relates to techniques for training and using neural networks to perform inference.

A neural network is a machine learning model used for a variety of different applications (e.g., image classification, computer vision, natural language processing, speech recognition, writing recognition, etc.). A neural network may be trained for a set of purposes by running datasets through it, comparing results from the neural network to known results, and updating the network parameters based on the differences.

### BRIEF DESCRIPTION OF THE DRAWINGS

Various embodiments of the present disclosure are illustrated by way of example and not limitation in the figures of the accompanying drawings.

FIG. 1 illustrates a hardware system according to some embodiments.

FIG. 2 illustrates an example neural network according to some embodiments.

FIG. 3 illustrates a data flow graph of the neural network illustrated in FIG. 2 according to some embodiments.

FIGS. 4A-4H illustrate an example schedule of operations to be performed by the hardware system illustrated in FIG. 1 for implementing the data flow graph illustrated in FIG. 3 according to some embodiments.

FIG. 5 illustrates a process for determining a schedule for processing a neural network on hardware according to some embodiments.

FIG. 6 depicts a simplified block diagram of an example computer system according to some embodiments.

FIG. 7 illustrates a neural network processing system according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described here are techniques for determining schedules for processing neural networks on hardware. In some embodiments, a system includes a processor, several hardware units, and memory. The hardware units are each configured to perform a certain set of operations. For example, a first hardware unit may be configured to read data from the memory, a second hardware unit may be configured to write data to the memory, a third hardware unit may be configured to perform matrix multiplication operations, a fourth hardware unit may be configured to perform activation functions, etc. The processor receives and executes a program that includes instructions for processing a neural network in the form of a data flow graph. To implement the instructions in the program, the processor can determine a schedule of operations that are to be performed by a set of the hardware units and distributes the schedule to the set of hardware units. The schedule of operations may include a specific set of instructions that are to be performed by the set of hardware units in a particular order. A peer-to-peer (P2P) communication mechanism may be implemented in the set of instructions to allow the set of hardware units to communicate with each other in an orderly manner.

The techniques described in the present application provide a number of benefits and advantages over conventional methods of processing neural networks on hardware. For instance, employing a P2P communication mechanism for hardware units to communicate with each other during execution of schedules of operations to implement neural network operations reduces latency in the system. This is because conventional methods of processing neural networks on hardware typically use the processor as a centralized arbiter where hardware units are required to communicate with it in order to control the schedule of operations. The techniques described in the present application eliminate the need for such a centralized arbiter, thereby reducing communication between the processor and the hardware units. Reducing latency can allow for higher hardware utilization.

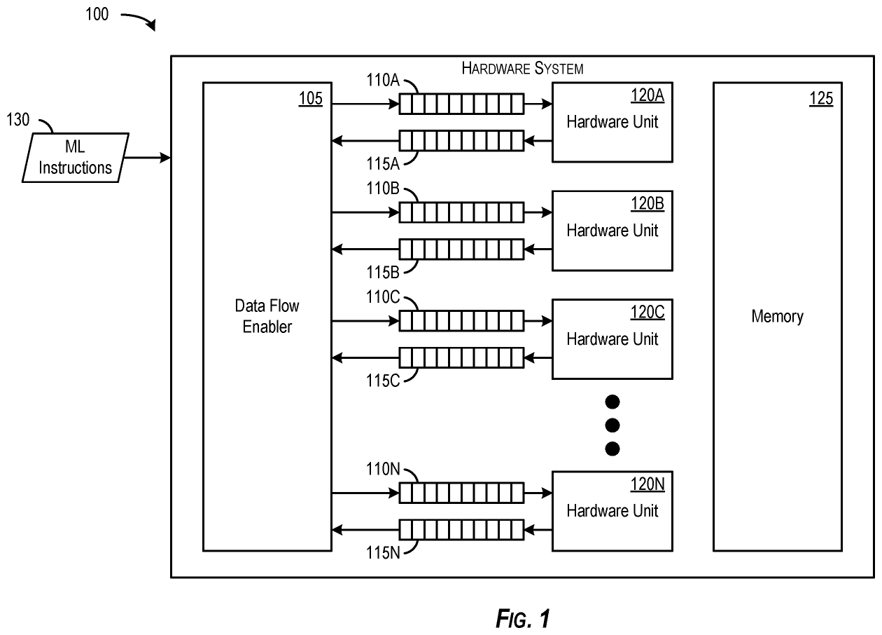

FIG. 1 illustrates a hardware system 100 according to some embodiments. As shown, system 100 includes data flow enabler 105, instruction queues 110A-N, response queues 115A-N, hardware units 120A-N, and memory 125. Each of the instruction queues 110A-N may be a queue that is configured to store instructions for a corresponding hardware unit 120. Each of the response queues 115A-N can be a queue that is configured to store responses generated by a corresponding hardware unit 120. In some embodiments, the queue used for instruction queues 110A-N and/or response queues 115A-N are a first in first out (FIFO) queues with multiple virtual channels, where each virtual channel is a FIFO in itself for a class of instructions. Memory 125 can be configured to store data for hardware system 100. For instance, memory 125 may be used to store matrices used in and/or generated during the processing of neural networks. In some embodiments, memory 125 may be random-access memory (RAM). In some cases, memory 125 can be volatile memory while, in other cases, memory 125 can be non-volatile memory.

Data flow enabler (DFE) 105 is responsible for executing instructions for processing data through neural networks (e.g., training neural networks, using neural networks to perform inference, etc.). For example, DFE 105 may receive machine learning (ML) instructions 130 for processing data through a neural network. In some embodiments, ML instructions 130 are implemented by a set of programs generated by an application (e.g., a programming integrated development environment (IDE) application). The application may generate the program based on a set of machine learning libraries (e.g., a set of Tensorflow libraries, a set of Pytorch libraries, a set of open neural network exchange (ONNX) libraries, etc.). ML instructions 130 can be expressed in terms of a data flow graph in some embodiments.

To process ML instructions 130, DFE 105 may determine a hardware definition that specifies hardware units 120A-N and the functions that each of the hardware units 120A-N is configured to perform. Based on the hardware definition, DFE 105 can determine a schedule of operations to be performed by one or more hardware units 120A-N to implement ML instructions 130. In some embodiments, DFE 105 determines the schedule by generating a set of instructions for each of the hardware units 120A-N used to implement ML instructions 130. Then, DFE 105 distributes the set of instructions to the instruction queues 110A-N of the respective hardware units 120A-N.

DFE 105 can receive responses from hardware units 120A-N via response queues 115A-N. A response may indicate that a particular hardware unit 120 has completed one or more successive instructions received from DFE 105. This allows DFE 105 to determine the availability of space in instruction queues 110A-N. In some cases, a response can indicate any error conditions encountered by hardware units 120A-N. In addition, DFE 105 may use the responses that DFE 105 receives from hardware units 120A-N to prepare future instructions to hardware units 120A-N.

In some embodiments, DFE 105 can be implemented as a hardware processor with software operating on the hardware processor. The software may include the logic for the operations that are described in the present application as being performed by DFE 105.

Each of the hardware units 120A-N is configured to perform a particular set of functions. Examples of such functions include reading data from memory 125, writing data to memory 125, performing matrix multiplication operations, performing activation operations, performing various types of element-wise operations, etc.

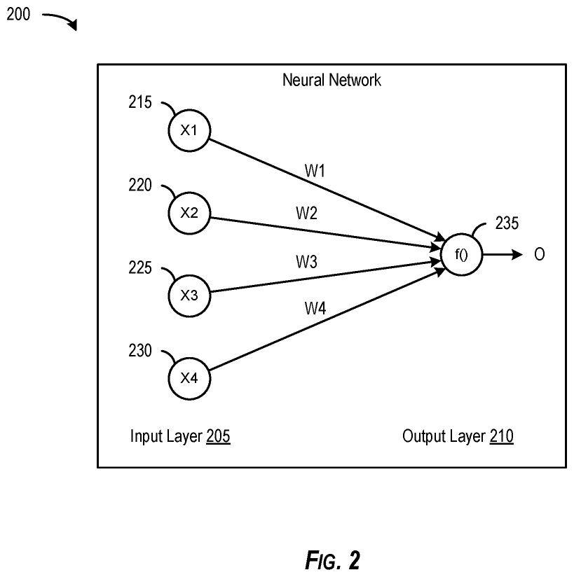

FIG. 2 illustrates an example neural network 200 according to some embodiments. As shown, neural network 200 includes input layer 205 and output layer 210. Input layer 205 includes four nodes 215-230. Each of the nodes 215-230 is configured to receive input data (e.g., training data). For this example, nodes 215-230 are shown to receive input data X1-X4. Output layer includes node 235. Node 235 is configured to perform a function f( ) on the products of the input data from input layer 205 and corresponding weights W1-W4 and generates an output O. In some embodiments, function f( ) may be an activation function (e.g., a rectified linear unit activation function, a linear activation function, a sigmoid activation function, a hyperbolic tangent activation function, etc.).

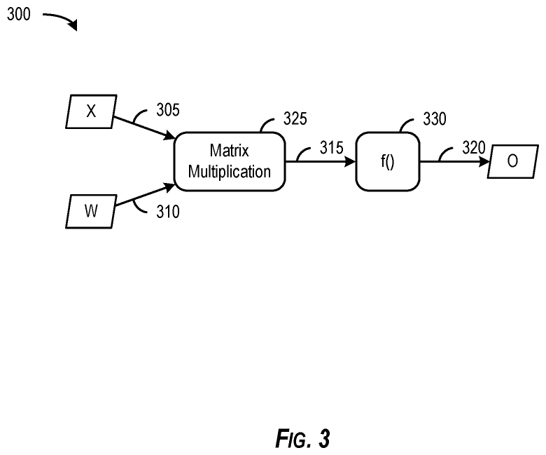

FIG. 3 illustrates a data flow graph 300 of neural network 200 according to some embodiments. As illustrated in FIG. 3, data flow graph 300 includes nodes 325 and 330 and edges 305-320, which are connected to nodes 325 and/or 330. In this example, each of the edges 305 represents a matrix. For instance, edge 305 represents a matrix X of input data X1-X4 in neural network 200 and edge 310 represents a matrix W of weights W1-W4 in neural network 200. Edge 315 represents a matrix output by node 325 and edge 320 represents a matrix output by node 330. Each of the nodes 325 and 330 represents a mathematical operation. For this example, node 325 represents a matrix multiplication operation that is performed on matrices X and W. Node 325 generates an output matrix that is the input to node 330. Node 330 represents a function f( ) that is performed on the output of node 325. Node 330 generates an output matrix O.

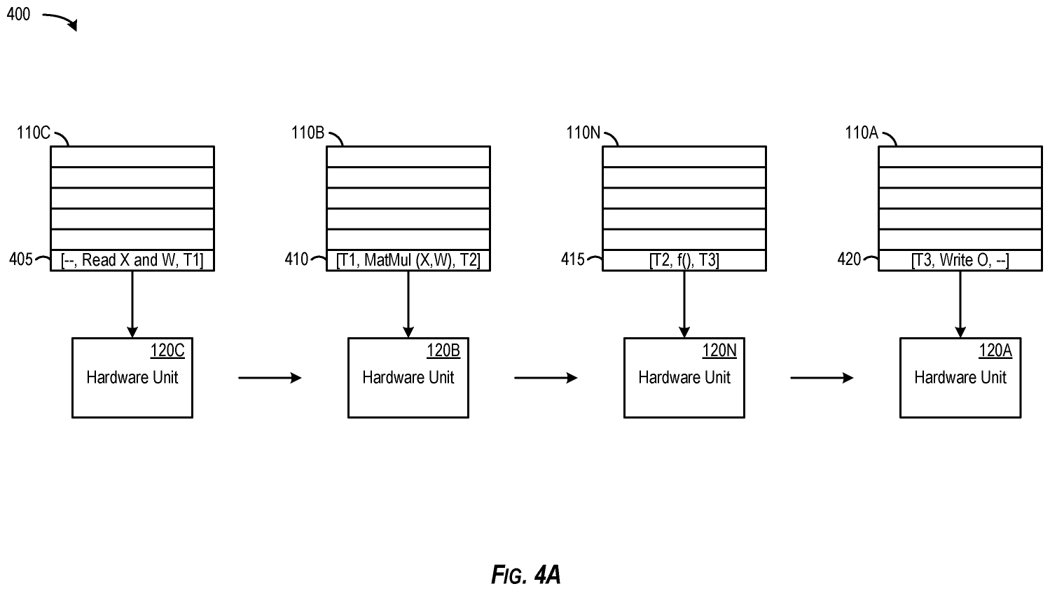

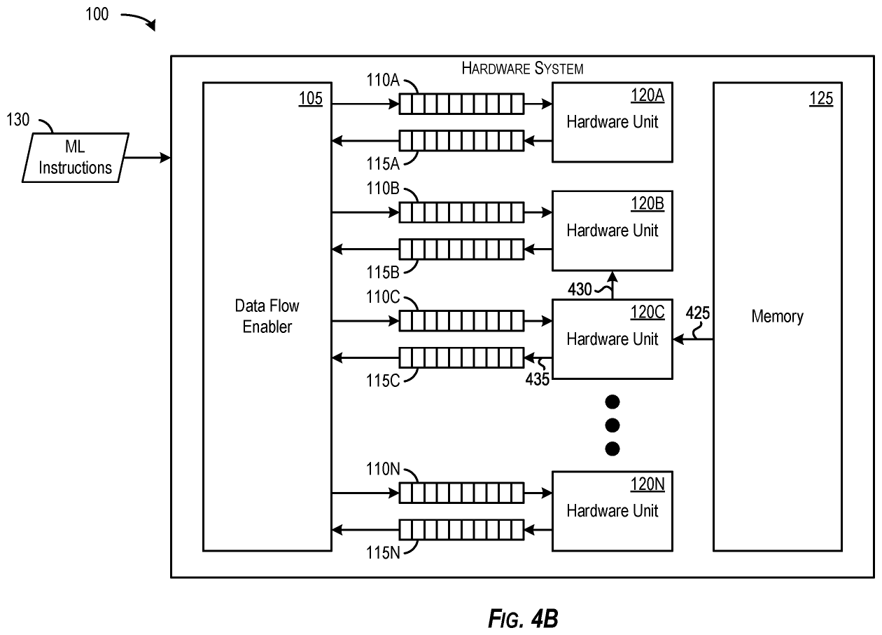

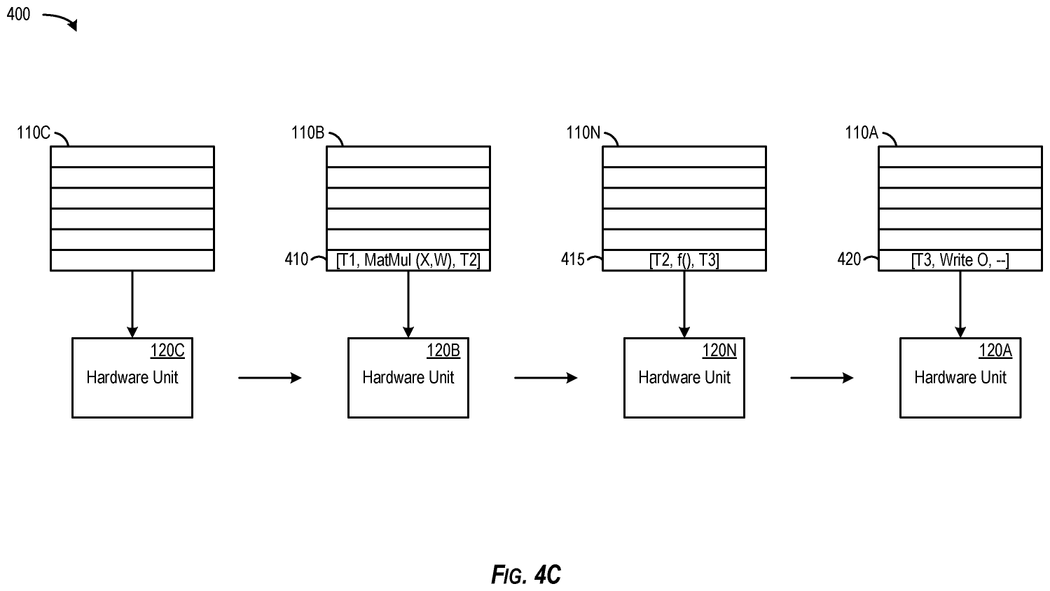

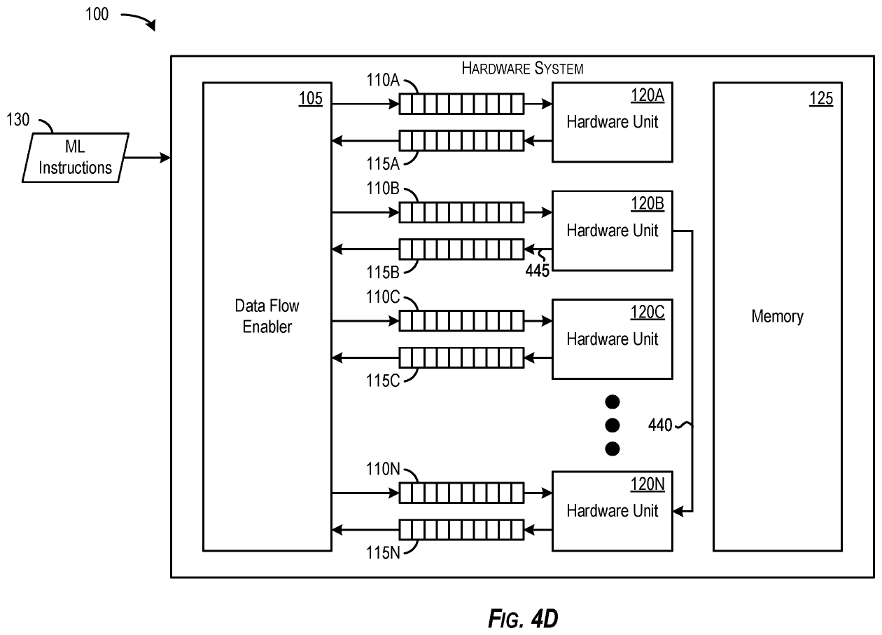

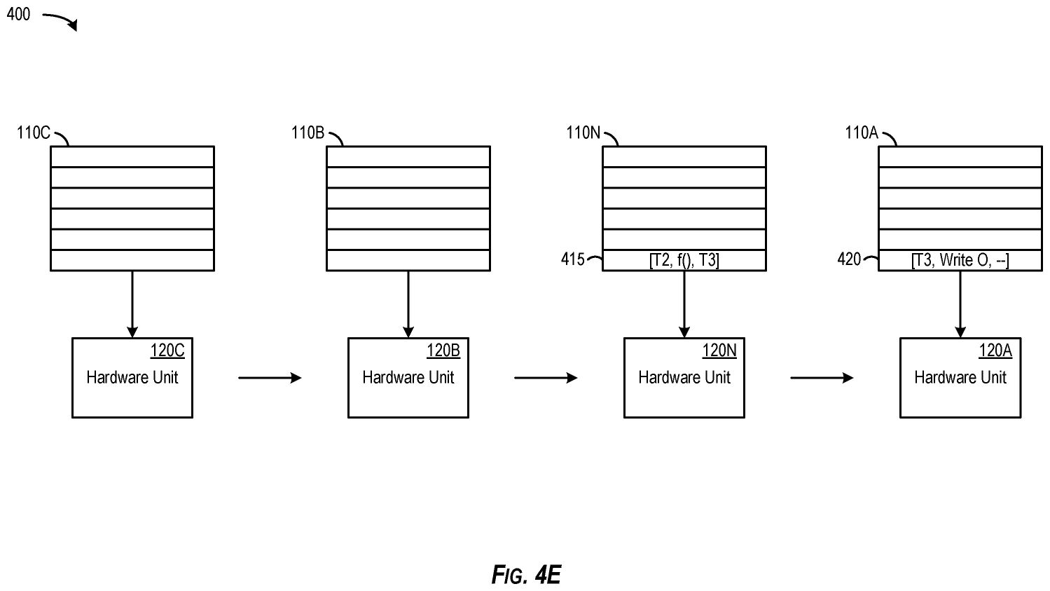

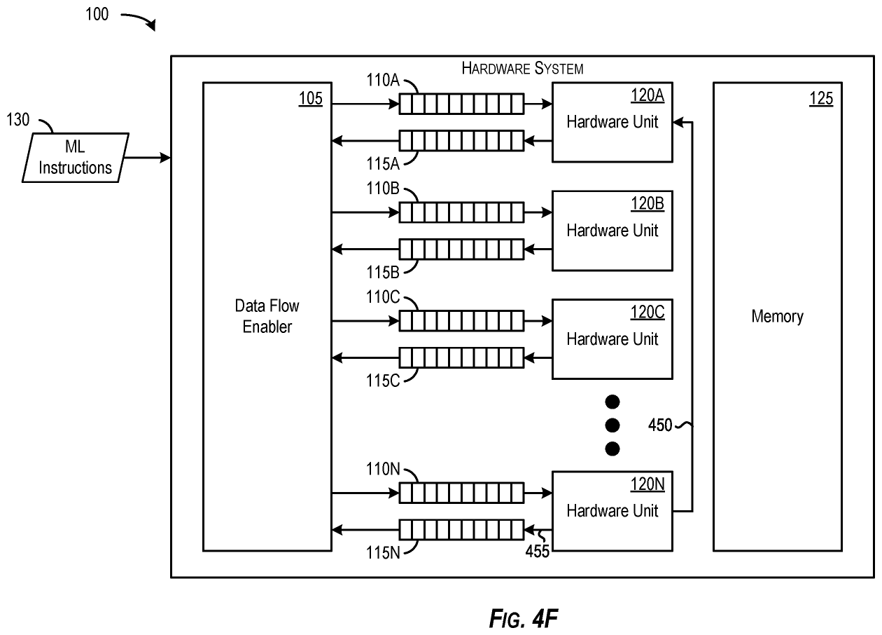

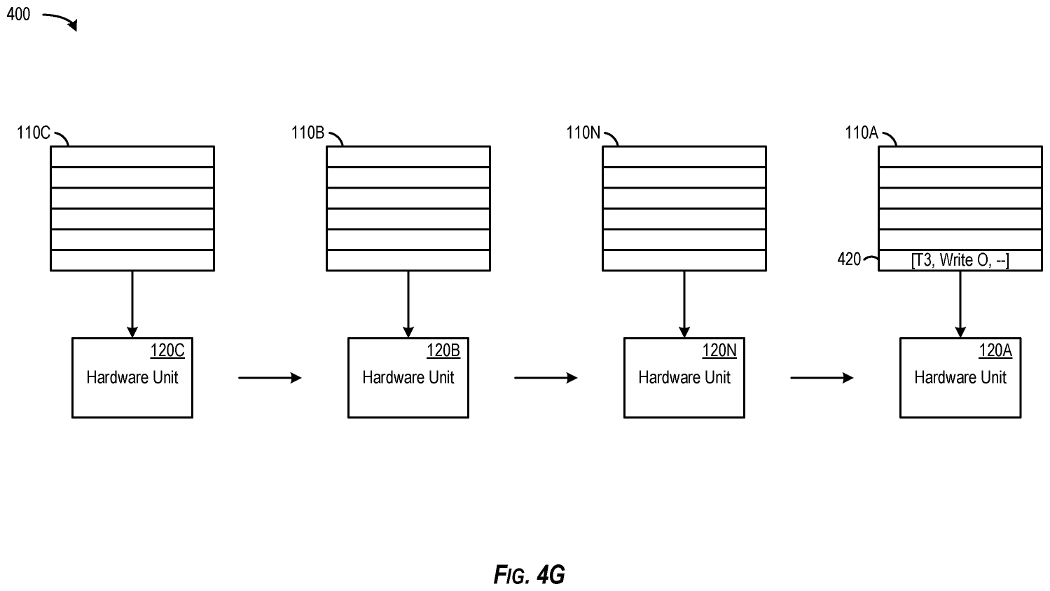

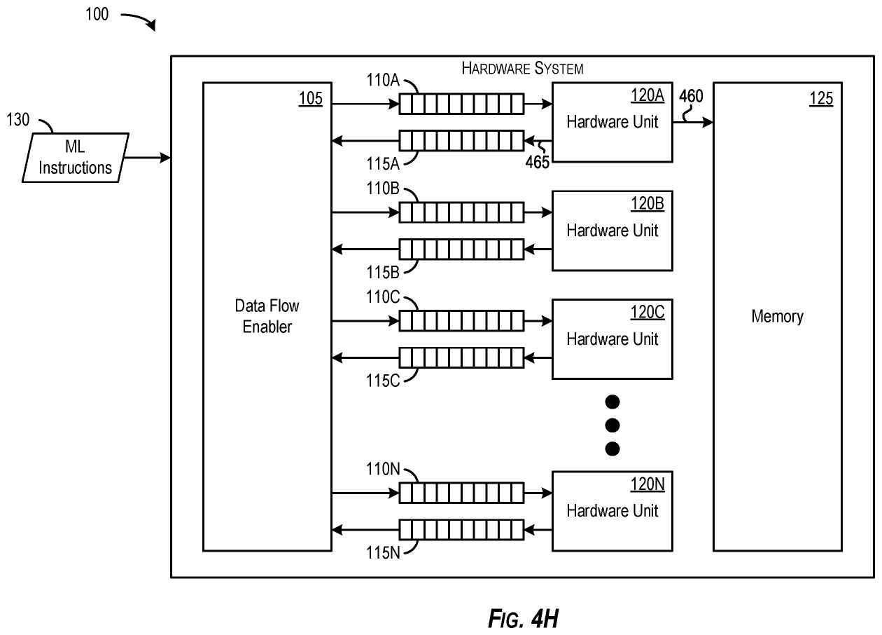

FIGS. 4A-4H illustrate an example schedule of operations to be performed by hardware system 100 for implementing data flow graph 300 according to some embodiments. For this example, ML instructions 130 includes instructions for processing data 215-230 through neural network 200. An application (e.g., a programming IDE application) generated a set of programs, which implements ML instructions 130, based on a set of machine learning libraries. The set of programs expresses ML instructions 130 in terms of data flow graph 300.

When DFE 105 receives ML instructions 130 (the set of programs in this example), DFE 105 determines a schedule of a set of operations that are to be performed by a set of hardware units 120A-N in order to implement ML instructions 130. In this example, hardware unit 120A is configured to write data to memory 125, hardware unit 120B is configured to perform matrix multiplication operations, hardware unit 120C is configured to read data from memory 125, and hardware unit 120N is configured to perform function f( ). Here, DFE 105 determines the schedule of the set of operations by generating a set of instructions for hardware units 120A, 120B, 120C, and 120N to implement ML instructions 130. Specifically, DFE 105 generates a first instruction to read input data X and W from memory 125, a second instruction to perform matrix multiplication on input data X and W, a third instruction to perform function f( ) on the output of the matrix multiplication operation, and a fourth instruction to write the output of function f( ) to memory 125. DFE 105 distributes these instructions to hardware units 120A, 120B, 120C, and 120N by sending the first instruction to hardware unit 120C via instruction queue 110C, sending the second instruction to hardware unit 120B via instruction queue 120B, sending the third instruction to hardware unit 120N via instruction queue 110N, and sending the fourth instruction to hardware unit 120BA via instruction queue 110A.

FIG. 4A illustrates instruction queues 110A, 110B, 110C and 110N after DFE 105 sends the four instructions to hardware units 120A, 120B, 120C and 120N. As shown in FIG. 4A, the first instruction 405 is stored in instruction queue 110C, the second instruction 410 is stored in instruction queue 110B, the third instruction is stored in instruction queue 110N, and the fourth instruction is stored in instruction queue 110A. As mentioned above, a P2P communication mechanism may be implemented in instructions to allow hardware units to communicate with each other. In addition, the P2P communication mechanism ensures that the schedule of the set of operations are performed in the order specified in the schedule. FIG. 4A also depicts such a P2P communication mechanism.

In some embodiments, a instruction that DFE 105 generates includes three parameters: a first token, an operation to perform upon receiving the first token, and an instruction to generate a second token after performing the operation and send the second token to a particular hardware unit. In some cases where the first token is null or empty, the operation can be performed without needing to receive a token (i.e., the operation is performed upon processing of the instruction). In other cases, the instruction to generate a second token may be null or empty. For such a instruction, the second token is not generated after the operation is performed. As illustrated in FIG. 4A, instruction 405 includes a null/empty value for the first token parameter, an operation to read matrices X and Y from memory 125 and send the matrices to hardware unit 120B, and an instruction to generate token T1 after performing the operation and send token T1 to hardware unit 120B. Instruction 410 includes token T1, an operation to perform matrix multiplication on matrices X and W and send the output of the matrix multiplication operation to hardware unit 120N, and an instruction to generate token T2 after performing the operation and send token T2 to hardware unit 120N. Instruction 415 includes token T2, an operation to perform function f( ) and send the output of the function f( ) to hardware unit 120A, and an instruction to generate token T3 after performing the operation and send token T3 to hardware unit 120A. Instruction 420 includes token T3, an operation to write an output matrix O to memory 125, and a null/empty value for the instruction parameter. In some embodiments, a instruction such as 410 can be made to wait on multiple tokens from multiple instructions from the same or different instruction queues.

FIG. 4B illustrates the data flow through hardware system 100 after DFE 105 has distributed instructions 405-420 to hardware units 120C, 120B, 120N, and 120A, via instruction queues 110C, 110B, 110N, and 110A, as shown in FIG. 4A. The data flow starts by hardware units 120A, 120B, 120C, and 120N starting to process the instructions 405-420 in their respective instruction queues 120A, 120B, 120C, and 120N. Hardware units 120A, 120B, and 120N cannot perform the operations specified in their respective instructions 420, 410, and 415 because they all require receiving a specified token. However, hardware unit 120C can perform the operation specified in instruction 405 because the first parameter is a null/empty value. As such, hardware unit 120C performs the operation specified in instruction 405 by retrieving, at 425, matrices X and W from memory. Next, hardware unit 120C generates token T1 and sends, at 430, token T1 along with matrices X and W to hardware unit 120B. Since hardware unit 120C has completed the processing of instruction 405, hardware unit 120C removes it from instruction queue 110C. Hardware unit 120C then generates a response indicating the completion of instruction 405 and sends, at 435, the response to DFE 105 via response queue 115C.

FIG. 4C illustrates instruction queues 110A, 110B, 110C and 110N after hardware unit 120C finished processing instruction 405. As shown, instruction queue 110C of hardware unit 120C is now empty. FIG. 4D illustrates the data flow through hardware system 100 after hardware unit 120C completed processing instruction 405. Upon receiving token T1 and matrices X and W from hardware unit 120C, hardware unit 120B can perform the operation specified in instruction 410. In particular, hardware unit 120B performs a matrix multiplication operation on matrices X and W. Then, hardware unit 120B generates token T2 and sends, at 440, token T2 and the output that it generated from the matrix multiplication operation to hardware unit 120N. As hardware unit 120B has completed the processing of instruction 410, hardware unit 120B removes it from instruction queue 110B. Next, hardware unit 120B generates a response indicating the completion of instruction 410 and sends, at 445, the response to DFE 105 via response queue 115B.

FIG. 4E illustrates instruction queues 110A, 110B, 110C and 110N after hardware unit 120B finished processing instruction 410. As depicted in FIG. 4E, instruction queue 110B of hardware unit 120B is now empty. FIG. 4F illustrates the data flow through hardware system 100 after hardware unit 120B completed processing instruction 410. Once hardware unit 120N receives token T2 and the output generated from the matrix multiplication operation, hardware unit 120N may perform the operation specified in instruction 415. Specifically, hardware unit 120N performs function f( ) on the output generated from the matrix multiplication operation. Next, hardware unit 120N generates token T3 and sends, at 450, token T3 and the output that it generated from function f( ) to hardware unit 120A. Since hardware unit 120N has completed the processing of instruction 415, hardware unit 120N removes it from instruction queue 110N. Then, hardware unit 120N generates a response indicating the completion of instruction 415 and sends, at 455, the response to DFE 105 via response queue 115N.

FIG. 4G illustrates instruction queues 110A, 110B, 110C and 110N after hardware unit 120N finished processing instruction 415. As illustrated in FIG. 4G, instruction queue 110N of hardware unit 120N is now empty. FIG. 4H illustrates the data flow through hardware system 100 after hardware unit 120N completed processing instruction 415. When hardware unit 120A receives token T3 and the output generated from function f( ), hardware unit 120A can perform the operation specified in instruction 420. In this example, hardware unit 120A writes, at 460, the output from function f( ) to memory 125. As the third parameter is instruction 420 is null/empty, hardware unit 120A has completed the processing of instruction 420. Thus, hardware unit 120A removes instruction 420 from instruction queue 110A. Next, hardware unit 120A generates a response indicating the completion of instruction 420 and sends, at 465, the response to DFE 105 via response queue 115A.

In some embodiments, DFE 105, instruction queues 110A-N, response queues 115A-N, hardware units 120A-N and memory 125 are implemented on a single chip. In some such embodiments, hardware system 100 can include additional chips similar to this chip. That is, these additional chips can include a DFE, instruction queues, response queues, hardware units, and memory similar to that shown in FIG. 1. In some embodiments, the processing of data through a neural network can be implemented across multiple chips. In some such embodiments, the schedule of operations can be distributed across one or more hardware units in different chips. The same or similar P2P communication mechanism described above by reference to FIGS. 4A-4H can be applied to facilitate communication between hardware units in different chips.

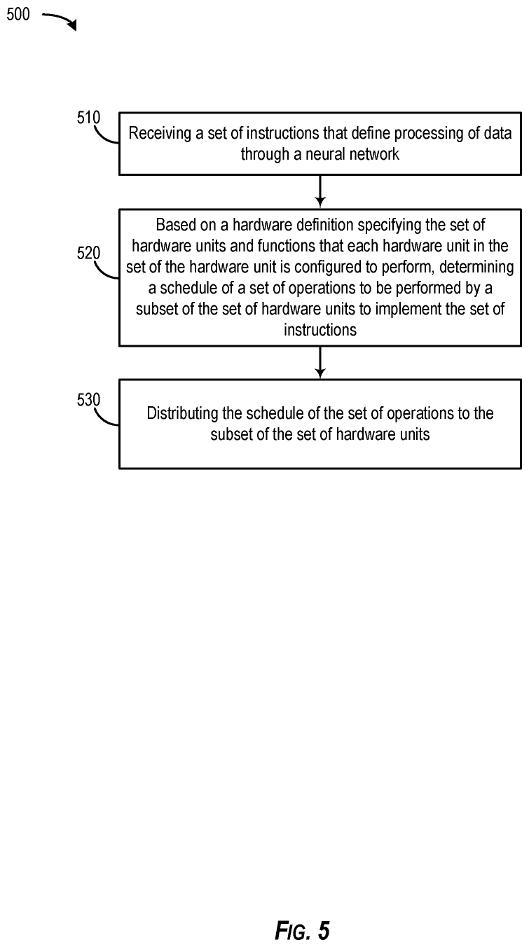

FIG. 5 illustrates a process 500 for determining a schedule for processing a neural network on hardware according to some embodiments. In some embodiments, hardware system 100 (e.g., DFE 105) performs process 500. Process 500 starts by receiving, at 510, a set of instructions that define processing of data through a neural network. Referring to FIG. 1 as an example, DFE 105 may receive ML instructions 130, which define processing data through neural network 200.

Based on a hardware definition specifying the set of hardware units and functions that each hardware unit in the set of the hardware unit is configured to perform, process 500 determines, at 520, a schedule of a set of operations to be performed by a subset of the set of hardware units to implement the set of instructions. Referring to FIGS. 1 and 4A as an example, DFE 105 can generate instructions 405-420 to implement ML instructions 130 based on a hardware definition that specifies hardware units 120A-N and their example functions mentioned above by reference to FIGS. 4A-4H.

Finally, process 500 distributes, at 530, the schedule of the set of operations to the subset of the set of hardware units. Referring to FIGS. 1 and 4A as an example, DFE 105 may distribute instructions 405-420 to hardware units 120C, 120B, 120N, and 120A, respectively, via instruction queues 110C, 110B, 110N, and 110A.

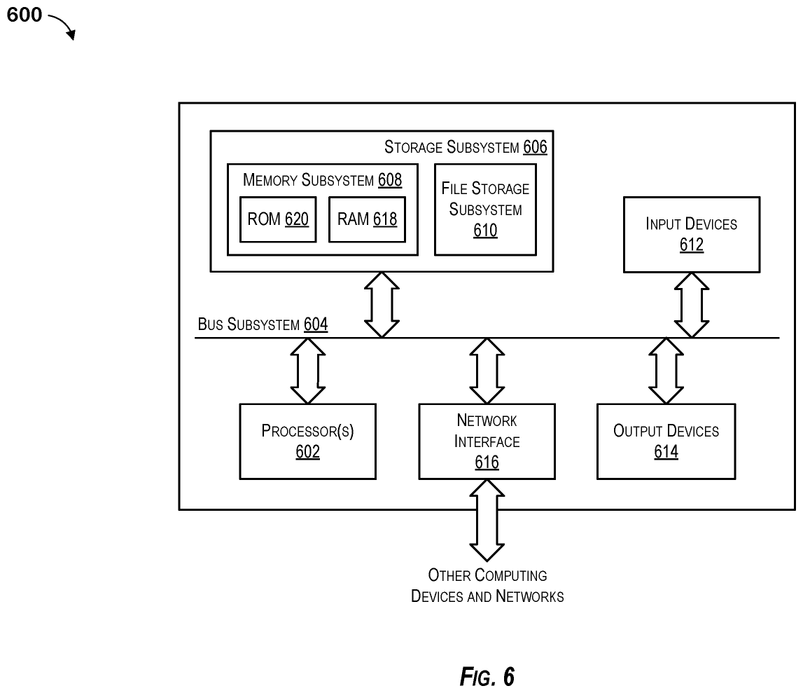

The techniques describe above may be implemented in a wide range of computer systems configured to process neural networks. FIG. 6 depicts a simplified block diagram of an example computer system 600, which can be used to implement the techniques described in the foregoing disclosure. As shown in FIG. 6, computer system 600 includes one or more processors 602 that communicate with a number of peripheral devices via a bus subsystem 604. These peripheral devices may include a storage subsystem 606 (e.g., comprising a memory subsystem 608 and a file storage subsystem 610) and a network interface subsystem 616. Some computer systems may further include user interface input devices 612 and/or user interface output devices 614.

Bus subsystem 604 can provide a mechanism for letting the various components and subsystems of computer system 600 communicate with each other as intended. Although bus subsystem 604 is shown schematically as a single bus, alternative embodiments of the bus subsystem can utilize multiple busses.

Network interface subsystem 616 can serve as an interface for communicating data between computer system 600 and other computer systems or networks. Embodiments of network interface subsystem 616 can include, e.g., Ethernet, a Wi-Fi and/or cellular adapter, a modem (telephone, satellite, cable, ISDN, etc.), digital subscriber line (DSL) units, and/or the like.

Storage subsystem 606 includes a memory subsystem 608 and a file/disk storage subsystem 610. Subsystems 608 and 610 as well as other memories described herein are examples of non-transitory computer-readable storage media that can store executable program code and/or data that provide the functionality of embodiments of the present disclosure.

Memory subsystem 608 includes a number of memories including a main random access memory (RAM) 618 for storage of instructions and data during program execution and a read-only memory (ROM) 620 in which fixed instructions are stored. File storage subsystem 610 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 600 is illustrative and many other configurations having more or fewer components than system 600 are possible.

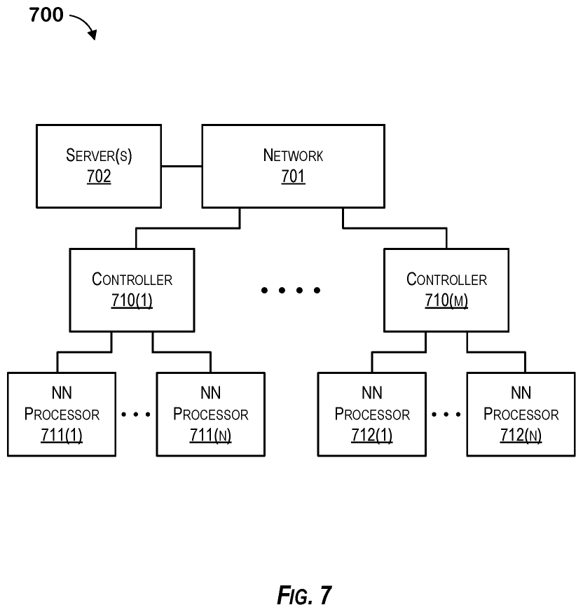

FIG. 7 illustrates a neural network processing system according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia Corp®), field programmable gate arrays (FPGA) (e.g., FPGAs for processing neural networks produced by Xilinx®), or a variety of application specific integrated circuits (ASICs) or neural network processors comprising hardware architectures optimized for neural network computations, for example. In this example environment, one or more servers 702, which may comprise architectures illustrated in FIG. 6 above, may be coupled to a plurality of controllers 710(1)-710(M) over a communication network 701 (e.g. switches, routers, etc.). Controllers 710(1)-710(M) may also comprise architectures illustrated in FIG. 6 above. Each controller 710(1)-710(M) may be coupled to one or more NN processors, such as processors 711(1)-711(N) and 712(1)-712(N), for example. NN processors 711(1)-711(N) and 712(1)-712(N) may include a variety of configurations of functional processing blocks and memory optimized for neural network processing, such as training or inference. The NN processors are optimized for neural network computations. In some embodiments, each NN processor can be implemented by hardware system 100. Server 702 may configure controllers 710 with NN models as well as input data to the models, which may be loaded and executed by NN processors 711(1)-711(N) and 712(1)-712(N) in parallel, for example. Models may include layers and associated weights as described above, for example. NN processors may load the models and apply the inputs to produce output results. NN processors may also implement training algorithms described herein, for example.

### Further Example Embodiments

In various embodiments, the present disclosure includes systems, methods, and apparatuses for determining schedules for processing neural networks on hardware. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in one embodiment, the present disclosure includes a system comprising a processor and a set of hardware units, wherein the processor is configured to receive a set of instructions that define processing of data through a neural network; based on a hardware definition specifying the set of hardware units and functions that each hardware unit in the set of the hardware unit is configured to perform, determine a schedule of a set of operations to be performed by a subset of the set of hardware units to implement the set of instructions; and distribute the schedule of the set of operations to the subset of the set of hardware units.

In one embodiment, the set of instructions are a first set of instructions. Determining the schedule of the set of operations comprises generating a second set of instructions for the subset of the set of hardware units, wherein distributing the schedule of the set of operations to the subset of the set of hardware units comprises distributing the second set of instructions to the subset of the set of hardware units.

In one embodiment, a first instruction in the second set of instructions is distributed to a first hardware unit in the subset of the set of hardware units. The instruction specifies an operation to perform and a second instruction to generate a token after performing the operation and send the token to a second hardware unit in the subset of the set of hardware units.

In one embodiment, a first instruction in the second set of instructions is distributed to a first hardware unit in the subset of the set of hardware units. The instruction specifies a first token, an operation to perform upon receiving the first token, and a second instruction to generate a second token after performing the operation and send the second token to a second hardware unit in the subset of the set of hardware units.

In one embodiment, an instruction in the second set of instructions is distributed to a hardware unit in the subset of the set of hardware units. The instruction specifies an operation to perform upon receiving a token.

In one embodiment, a first instruction in the second set of instructions is distributed to a first hardware unit in the subset of the set of hardware units. The first instruction specifies a first operation to perform and a second instruction to generate a first token after performing the first operation and send the first token to a second hardware unit in the subset of the set of hardware units. A third instruction in the second set of instructions is distributed to the second hardware unit. The third instruction specifies a second operation to perform upon receiving the first token and a fourth instruction to generate a second token after performing the second operation and send the second token to a third hardware unit in the subset of the set of hardware units. A fifth instruction in the second set of instructions is distributed to the third hardware unit. The fifth instruction specifying a third operation to perform upon receiving the second token.

In one embodiment, the present disclosure further comprises memory. One of the first, second, and third hardware units is configured to read data from the memory. One of the first, second, and third operations distributed to the one of the first, second, and third hardware units is to retrieve the data from the memory.

In one embodiment, the present disclosure further comprises memory. One of the first, second, and third hardware units is configured to write data to the memory. One of the first, second, and third operations distributed to the one of the first, second, and third hardware units is to write the data to the memory.

In one embodiment, one of the first, second, and third hardware units is configured to perform matrix multiplication operations. One of the first, second, and third operations distributed to the one of the first, second, and third hardware units is to perform a matrix multiplication operation on a first matrix and a second matrix.

In one embodiment, one of the first, second, and third hardware units is configured to perform activation functions. One of the first, second, and third operations distributed to the one of the first, second, and third hardware units is to perform an activation function.

In one embodiment, the processor is a first processor and the set of hardware units is a first set of hardware units. The present disclosure further comprises a first chip and a second chip. The first chip includes the first processor and the first set of hardware units. The second chip includes a second processor and a second set of hardware units. The schedule of the set of operations is to be further performed by a subset of the second set of hardware units. The set of instructions is a first set of instructions. Determining the schedule of the set of operations further comprises determining a third set of instructions and sending the third set of instructions to the subset of the second set of hardware units.

In one embodiment, the present disclosure further comprises a set of queues. Each queue in the set of queues is configured to store instructions for a hardware unit in the set of hardware units. Distributing the second set of instructions to the subset of the set of hardware units comprises sending the second set of instructions to a subset of the set of queues for the subset of the set of hardware units.

In one embodiment, the set of instructions are implemented in a program generated by an application.

In one embodiment, the program is generated based on a set of machine learning libraries.

In one embodiment, the set of instructions are expressed in terms of a data flow graph.

In one embodiment, the data flow graph comprises a set of nodes and a set of edges connecting the set of nodes. Each node in the set of nodes represents a mathematical operation. Each edge in the set of edges represents a matrix on which a particular instance of a mathematical operation is performed.

In one embodiment, the processing of the data through the neural network comprises training the neural network based on the data.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A system comprising:
a processor; and
a set of hardware units,
wherein the processor is configured to:
receive a set of instructions that define processing of data through a neural network;
based on a hardware definition specifying the set of hardware units and functions that each hardware unit in the set of the hardware unit is configured to perform, determine a schedule of a set of operations to be performed by a subset of the set of hardware units to implement the set of instructions; and
distribute the schedule of the set of operations to the subset of the set of hardware units.

2. The system of claim 1, wherein the set of instructions are a first set of instructions, wherein determining the schedule of the set of operations comprises generating a second set of instructions for the subset of the set of hardware units, wherein distributing the schedule of the set of operations to the subset of the set of hardware units comprises distributing the second set of instructions to the subset of the set of hardware units.

3. The system of claim 2, wherein a first instruction in the second set of instructions is distributed to a first hardware unit in the subset of the set of hardware units, the instruction specifying an operation to perform and a second instruction to generate a token after performing the operation and send the token to a second hardware unit in the subset of the set of hardware units.

4. The system of claim 2, wherein a first instruction in the second set of instructions is distributed to a first hardware unit in the subset of the set of hardware units, the instruction specifying a first token, an operation to perform upon receiving the first token, and a second instruction to generate a second token after performing the operation and send the second token to a second hardware unit in the subset of the set of hardware units.

5. The system of claim 2, wherein an instruction in the second set of instructions is distributed to a hardware unit in the subset of the set of hardware units, the instruction specifying an operation to perform upon receiving a token.

6. The system of claim 2, wherein a first instruction in the second set of instructions is distributed to a first hardware unit in the subset of the set of hardware units, the first instruction specifying a first operation to perform and a second instruction to generate a first token after performing the first operation and send the first token to a second hardware unit in the subset of the set of hardware units, wherein a third instruction in the second set of instructions is distributed to the second hardware unit, the third instruction specifying a second operation to perform upon receiving the first token and a fourth instruction to generate a second token after performing the second operation and send the second token to a third hardware unit in the subset of the set of hardware units, wherein a fifth instruction in the second set of instructions is distributed to the third hardware unit, the fifth instruction specifying a third operation to perform upon receiving the second token.

7. The system of claim 6, wherein the system further comprises memory, wherein one of the first, second, and third hardware units is configured to read data from the memory, wherein one of the first, second, and third operations distributed to the one of the first, second, and third hardware units is to retrieve the data from the memory.

8. The system of claim 6, wherein the system further comprises memory, wherein one of the first, second, and third hardware units is configured to write data to the memory, wherein one of the first, second, and third operations distributed to the one of the first, second, and third hardware units is to write the data to the memory.

9. The system of claim 6, wherein one of the first, second, and third hardware units is configured to perform matrix multiplication operations, wherein one of the first, second, and third operations distributed to the one of the first, second, and third hardware units is to perform a matrix multiplication operation on a first matrix and a second matrix.

10. The system of claim 6, wherein one of the first, second, and third hardware units is configured to perform activation functions, wherein one of the first, second, and third operations distributed to the one of the first, second, and third hardware units is to perform an activation function.

11. The system of claim 2, wherein the processor is a first processor, wherein the set of hardware units is a first set of hardware units, wherein the system further comprises a first chip and a second chip, wherein the first chip includes the first processor and the first set of hardware units, wherein the second chip includes a second processor and a second set of hardware units, wherein the schedule of the set of operations is to be further performed by a subset of the second set of hardware units, wherein determining the schedule of the set of operations further comprises:
determining a third set of instructions; and
sending the third set of instructions to the subset of the second set of hardware units.

12. The system of claim 2, wherein the system further comprises a set of queues, each queue in the set of queues configured to store instructions for a hardware unit in the set of hardware units, wherein distributing the second set of instructions to the subset of the set of hardware units comprises sending the second set of instructions to a subset of the set of queues for the subset of the set of hardware units.

13. The system of claim 1, wherein the set of instructions are implemented in a program generated by an application.

14. The system of claim 13, wherein the program is generated based on a set of machine learning libraries.

15. The system of claim 13, wherein the set of instructions are expressed in terms of a data flow graph.

16. The system of claim 15, wherein the data flow graph comprises a set of nodes and a set of edges connecting the set of nodes, wherein each node in the set of nodes represents a mathematical operation, wherein each edge in the set of edges represents a matrix on which a particular instance of a mathematical operation is performed.

17. The system of claim 1, wherein the processing of the data through the neural network comprises training the neural network based on the data.

18. A method comprising:
receiving a set of instructions that define processing of data through a neural network;
based on a hardware definition specifying the set of hardware units and functions that each hardware unit in the set of the hardware unit is configured to perform, determining a schedule of a set of operations to be performed by a subset of the set of hardware units to implement the set of instructions; and
distributing the schedule of the set of operations to the subset of the set of hardware units.

19. The method of claim 18, wherein the set of instructions is a first set of instructions, wherein determining the schedule of the set of operations comprises generating a second set of instructions for the subset of the set of hardware units, wherein distributing the schedule of the set of operations to the subset of the set of hardware units comprises distributing the second set of instructions to the subset of the set of hardware units.

20. The method of claim 19, wherein a first instruction in the second set of instructions is distributed to a first hardware unit in the subset of the set of hardware units, the first instruction specifying a first operation to perform and a second instruction to generate a first token after performing the first operation and send the first token to a second hardware unit in the subset of the set of hardware units, wherein a third instruction in the second set of instructions is distributed to the second hardware unit, the third instruction specifying a second operation to perform upon receiving the first token and a fourth instruction to generate a second token after performing the second operation and send the second token to a third hardware unit in the subset of the set of hardware units, wherein a fifth instruction in the second set of instructions is distributed to the third hardware unit, the fifth instruction specifying a third operation to perform upon receiving the second token.
